(19) United States
(12) Patent Application Publication
(10) Pub. No.: US 2008/0070628 A1
(43) Pub. Date: Mar. 20, 2008

(54) Monitor apparatus for communication terminal

(75) Inventor: Yu-An Chang, Hsinchu (TW)

Correspondence Address: BACON & THOMAS, PLLC, 625 SLATERS LANE, FOURTH FLOOR, ALEXANDRIA, VA, 22314, US

(73) Assignee: Phison Electronics Corp., Hsinchu (TW)

(21) Appl. No.: 11/522,955

(22) Filed: Sep. 19, 2006

(51) Int. Cl. H04B 1/38

(52) U.S. Cl. 455/558

(57) ABSTRACT

A monitor apparatus for use in the communication terminal is disclosed. Meanwhile, the control method for extending services of a communication terminal, includes the steps of a) issuing a command signal; b) determining whether the command signal is an authentication command or an access command; c) passing the authentication command to the SIM while the command signal is the authentication command; d) sending the access command to a memory controller while the command signal is the access command; and e) accessing the auxiliary memory by the memory controller after receiving the access command.

### FIELD OF THE INVENTION

The present invention relates to a monitor apparatus, and more particularly, to a monitor apparatus for use in a communication terminal, i.e., a mobile phone, thereby extending the mobile-platform thereof.

### BACKGROUND OF THE INVENTION

Nowadays mobile equipment systems generally use special smart card applications, wherein the mobile station could be divided into a mobile equipment part and a network/subscriber-specific part. The mobile equipment part is functioning in a mobile equipment system of a defined type; and the network/subscriber-specific part is known more generally as a SIM (Subscriber Identity Module) facility. Meanwhile, mobile communication network operators and mobile terminal manufacturers make available to their customers an increasing number of services and applications. However, many known wireless mobile communication devices (“mobile devices”) support different types of communication network connections and data exchange with different information sources or destination systems. Furthermore, modern mobile phones are often enabled for both data and voice communications and typically exchange both public and private information with a remote communication terminal, including web servers on the Internet and data servers associated with a user's employer.

In practice, data for mobile devices is stored on a small silicon chip of SIM card connected with the terminal equipment. At least storing means are arranged on the chip for storing the above-mentioned data and for using it in the terminal equipment as well as a possible micro controller functioning as the processor unit. In some environments the processor functionality may also be arranged in the terminal equipment module proper.

For SIM cards of the known kind there is a standard connection in the mobile terminal equipment including connecting pins for connecting it electrically to the terminal equipment. The micro controller possibly placed on the SIM card is used to carry out the SIM application, which has several different manufacturers. In the state of the art, the use of mobile telecommunications and its importance is rapidly increasing in both the private and business sectors. In an effort to attract new customers and to keep existing customers, network operators try to offer a variety of service options. Ideally, network operators would like to be able to introduce new services quickly and to have these services unique to their own networks.

Currently, network operators offer services such as voicemail, address books and up to date information such as stock market quotations. A user selects which services he wants when he chooses his network operator and phone. Other services may be added by contacting his network operator. Services such as stock market quotations are provided by a point-to-point connection with his network operator. However, it is not easy to overcome the significant cost items caused by design and structural limitations and size limitations of SIM card. Therefore, a lot of additional network elements are introduced to combine with the original SIM card for increasing services and applications without increasing the cost too much.

However, if an additional network element is added, then it is necessary to ensure that it “agrees” with the already existing network elements, that is to say that it has the correct interface to the network and has the correct drivers. The compatibility between the SIM card system and the terminal system should be considered. Hence, it needs to provide a control integrated circuit (IC) module used in the communication terminal for facilitating to extend elements, such as a MMC/SD or Flash memory. The invention disclosed herein fulfills this need.

Accordingly, it needs to provide a control integrated circuit (IC) system with a monitor apparatus for use in the communication terminal, which provides a monitor apparatus to extend the mobile-platform, thereby facilitating to develop additional elements and to provide more storage memory for the communication terminal, further facilitating to extend the services from the original SIM card, and can rectify those drawbacks of the prior art and solve the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

Accordingly, the prior art is limited by the above problems. It is an object of the present invention to provide a control integrated circuit (IC) system with a monitor apparatus for use in the communication terminal, which provides a monitor apparatus to extend the mobile-platform, thereby facilitating to develop additional elements and to provide more storage memory for the communication terminal, further facilitating to extend the services from the original SIM card, and can rectify those drawbacks of the prior art and solve the above problems.

In accordance with an aspect of the present invention, the monitor apparatus for use in a communication terminal, includes means for determining whether a command signal issued from the communication terminal is an authentication command or an access command; a memory controller; and a traffic switch for passing the command signal to the SIM while the command signal is the authentication command or sending the command signal to the memory controller while the command signal is the access command; wherein the memory controller accesses an auxiliary memory after receiving the access command.

Preferably, the auxiliary memory is integrated on the SIM.

Preferably, the communication terminal is one of a mobile phone and a personal digital assistant.

Preferably, the auxiliary memory is a NAND flash memory.

Preferably, the auxiliary memory is stored with a Java virtual machine.

It is another object of the present invention to provide a control method for extending services of a communication terminal, which provides a monitor apparatus to extend the mobile-platform, thereby facilitating to develop additional elements and to provide more storage memory for the communication terminal, further facilitating to extend the services from the original SIM card, and can rectify those drawbacks of the prior art and solve the above problems.

In accordance with an aspect of the present invention, the control method for extending services of a communication terminal, includes the steps of a) issuing a command signal; b) determining whether the command signal is an authentication command or an access command; c) passing the authentication command to the SIM while the command signal is the authentication command; d) sending the access command to a memory controller while the command signal is the access command; and e) accessing the auxiliary memory by the memory controller after receiving the access command.

Preferably, the communication terminal is one of a mobile phone and a personal digital assistant.

Preferably, the auxiliary memory is a NAND flash memory.

Preferably, the auxiliary memory is stored with a Java virtual machine.

The above objects and advantages of the present invention will become more readily apparent to those ordinarily skilled in the art after reviewing the following detailed description and accompanying drawings, in which:

### BRIEF DESCRIPTION OF THE DRAWING

FIG. 1 illustrates an embodiment of a monitor apparatus for use in communication terminal provided with a SIM card, according to the present invention; and

FIG. 2 illustrates an embodiment of the control method for extending services of a communication terminal according to the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

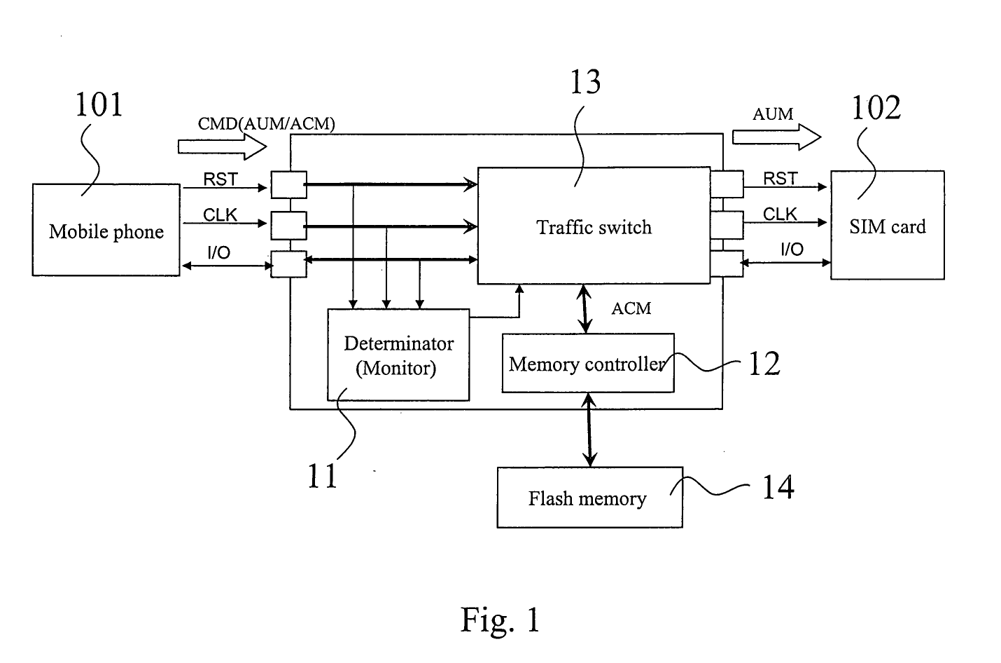

Please refer to FIG. 1. It illustrates an embodiment of a monitor apparatus for use in communication terminal 101 provided with a Subscriber Identity Module (SIM) card 102. The monitor apparatus includes a determinator 11 for determining whether a command signal CMD issued from the communication terminal 101 is an authentication command AUM or an access command ACM; a memory controller 12; and a traffic switch 13 for passing the command signal CMD to the SIM card 102 while the command signal CMD is the authentication command AUM or sending the command signal CMD to the memory controller 12 while the command signal CMD is the access command ACM. The memory controller 12 accesses an auxiliary memory 14 after receiving the access command ACM.

In practice, the communication terminal 101 can be one of a mobile phone and a personal digital assistant. In this embodiment, the communication terminal 101 is a mobile phone. The auxiliary memory 14 is a NAND flash memory and stored with a Java virtual machine. Furthermore, the monitor apparatus further includes a flash interface connected between the auxiliary memory 14 and the memory controller 12, thereby the auxiliary memory 14 being a detachable memory in accordance with the memory controller 12. Certainly, the command signal CMD is issued and transmitted via a bus, wherein the bus is disposed between the communication terminal 101 and the SIM card 102. Furthermore, the bus includes a RST port, a CLK, and an IO port being monitored by the monitor apparatus. The communication terminal 101 transmits the RST and CLK information to the SIM card 102 via the bus. The communication terminal 101 transmits data to the determinator 11 via the IO port. Furthermore, the memory controller 12 transmits data from the auxiliary memory 14 to the communication terminal 101 through the traffic switch 13 and the IO port. In other words, the monitor apparatus is intervened in an original bus disposed between the communication terminal 101 and the SIM card 102. Accordingly, the monitor apparatus for use in communication terminal provided with a Subscriber Identity Module (SIM) card facilitates to develop additional elements and to provide more storage memory for the communication terminal, further facilitating to extend the services.

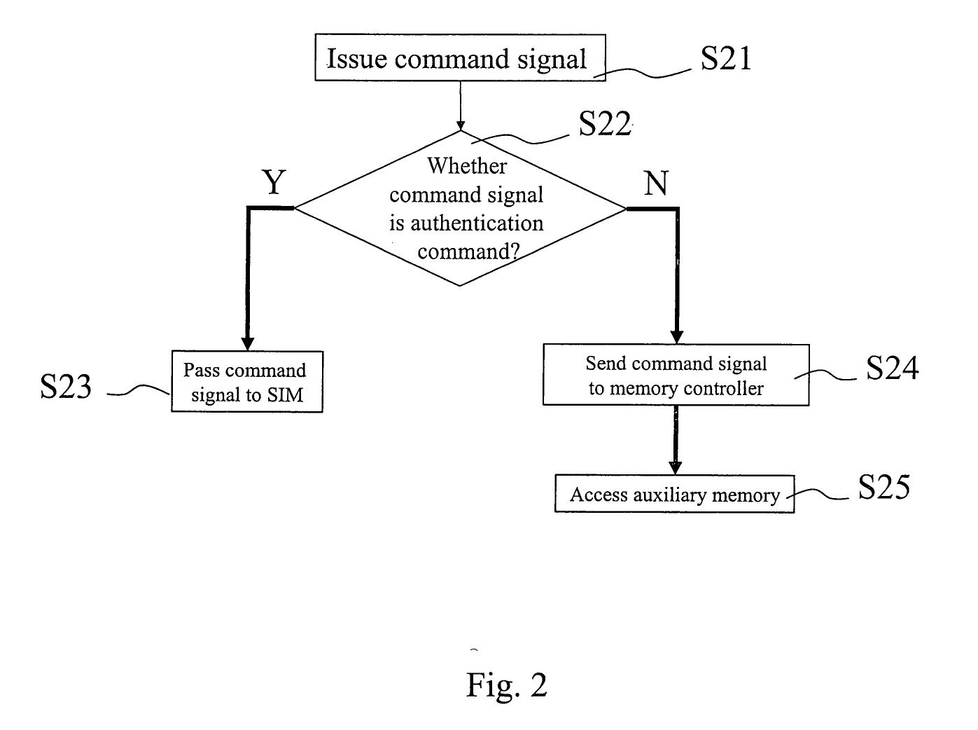

According to the above structure, the present invention further discloses a control method for extending services of a communication terminal. Please refer to FIG. 2. It illustrates a flow chart of the control method for extending services of a communication terminal according to the present invention. As shown in FIG. 2, the control method includes the steps of a) issuing a command signal, as shown in step S21, wherein the command signal could be an authentication command or an access command; b) determining whether the command signal is an authentication command or an access command, as shown in step S22; c) passing the authentication command to the SIM while the command signal is the authentication command, as shown in step S23; d) sending the access command to a memory controller while the command signal is the access command, as shown in step S24; and e) accessing the auxiliary memory by the memory controller after receiving the access command, as shown in step S25.

Certainly, the control method is executed via the above monitor apparatus. After disposing the monitor apparatus between the communication terminal 101 and the SIM card 102 as shown in FIG. 1, the control method will be executed, wherein the command signal is issued from the communication terminal. Moreover, the step b) is executed via the determinator 11 as shown in FIG. 1; and the step c) and the step d) are executed via the traffic switch 13 as shown in FIG. 1. The monitor apparatus is intervened in an original bus disposed between the communication terminal 101 and the SIM card 102, wherein the bus includes a RST port, a CLK, and an IO port being monitored by the monitor apparatus, wherein the communication terminal 101 transmits the RST and CLK information to the SIM card 102 via the bus. The communication terminal 101 transmits data to the determinator 11 via the IO port. Furthermore, the memory controller 12 transmits data from the auxiliary memory 14 to the communication terminal 101 through the traffic switch 13 and the IO port. Accordingly, the control method of the present invention introduces the monitor apparatus disposed between the communication terminal and the SIM card to facilitate to develop additional elements and to provide more storage memory for the communication terminal, further facilitate to extend the services.

In conclusion, the present invention provides a monitor apparatus for use in the communication terminal and the control method thereof, which provides an interface to extend the mobile-platform, thereby facilitating to develop additional elements and to provide more storage memory for the communication terminal, further facilitating to extend the services from the original SIM card, but the prior art fail to disclose that. Accordingly, the present invention possesses many outstanding characteristics, effectively improves upon the drawbacks associated with the prior art in practice and application, bears novelty, and adds to economical utility value. Therefore, the present invention exhibits a great industrial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A monitor apparatus for use in a communication terminal provided with a Subscriber Identity Module (SIM), comprising:
means for determining whether a command signal issued from said communication terminal is an authentication command or an access command;
a memory controller; and
a traffic switch for passing said command signal to said SIM while said command signal is said authentication command or sending said command signal to said memory controller while said command signal is said access command;
wherein said memory controller accesses an auxiliary memory after receiving said access command.

2. The monitor apparatus according to claim 1, wherein said auxiliary memory is integrated on said SIM.

3. The monitor apparatus according to claim 1, wherein said communication terminal is one of a mobile phone and a personal digital assistant.

4. The monitor apparatus according to claim 1, wherein said auxiliary memory is a NAND flash memory.

5. The monitor apparatus according to claim 1, wherein said auxiliary memory is stored with a Java virtual machine.

6. A control method for extending services of a communication terminal provided with a Subscriber Identity Module (SIM) having an auxiliary memory thereon, comprising the steps of:
a) issuing a command signal;
b) determining whether said command signal is an authentication command or an access command;
c) passing said authentication command to said SIM while said command signal is said authentication command;
d) sending said access command to a memory controller while said command signal is said access command; and
e) accessing said auxiliary memory by said memory controller after receiving said access command.

7. The control method according to claim 6, wherein said communication terminal is one of a mobile phone and a personal digital assistant.

8. The control method according to claim 6, wherein said auxiliary memory is a NAND flash memory.

9. The control method according to claim 6, wherein said auxiliary memory is stored with a Java virtual machine.
